(19) United States
(12) Patent Application Publication
(10) Pub. No.: US 2026/0083137 A1
(43) Pub. Date: Mar. 26, 2026

(54) HEAT-TREATMENT INSTALLATION FOR FOOD PRODUCTS

(71) Applicant: ARMOR INOX, Mauron (FR)

(72) Inventor: Pierre-Loïc COURTIAL, Mauron (FR)

(73) Assignee: ARMOR INOX, Mauron (FR)

(21) Appl. No.: 19/329,175

(22) Filed: Sep. 15, 2025

(30) Foreign Application Priority Data
Sep. 24, 2024 (FR) 2410182

(51) Int. Cl. A21B 1/48; B65G 17/12

(52) U.S. Cl. CPC A21B 1/48; B65G 17/12; B65G 2201/0202; B65G 2812/017

(57) ABSTRACT

A heat-treatment installation with a plurality of transport lines disposed one above the other, trays with two wheels and a latch, lifts for lifting a tray from a lower transport line to another upper transport line, rails on which the trays travel, and transmission belts with counter-latches cooperating with the latches of the trays where, at each lift, each rail has a gate arranged to open when a tray is raised and to close when the tray is above the rail.

### TECHNICAL FIELD

The present invention relates to a heat-treatment installation for food products.

### PRIOR ART

Food products must undergo various heat treatments to be heated and to be cooled. Various heat-treatment installations make it possible to provide such heat treatments. The document EP-A-1 127 814 shows an installation that extends over several stages and makes it possible to transport trays over these various levels. The installation comprises, among other things, a chain that is mounted between a plurality of toothed wheels and travels over all the levels. Each tray is secured to the chain by the horizontal shaft and, at each change of stage, the installation comprises an additional notched wheel that supports another shaft secured to the tray to provide a rising/descent of the tray while ensuring that the latter remains horizontal.

Even though such an installation is satisfactory, there remain problems to be solved. For example, the trays remain secured to the chain and cannot therefore be separated therefrom. Cleaning the installation is then relatively complex. This is because it is not possible to clean each tray individually and this cleaning must therefore be done directly on the installation. Furthermore, the chain is relatively long and, should it break, repairing same may be complex.

### DISCLOSURE OF THE INVENTION

One object of the present invention is therefore to propose a heat-treatment installation for food products that among other things makes it possible to release the trays with respect to the means providing movement thereof.

For this purpose, a heat-treatment installation is proposed having a vertical midplane parallel to an insertion direction and comprising:
a plurality of transport lines extending parallel to the insertion direction one above the other between an upstream zone and a downstream zone,
at least one tray having, on either side of the vertical midplane, two wheels and a latch,
a downstream lift in the downstream zone and an upstream lift in the upstream zone, wherein each lift is arranged to move at least one tray from a lower transport line to another upper transport line,
for each pair of a lower transport line and an upper transport line:
on either side of the vertical midplane, a lower rail and an upper rail extending parallel to the insertion direction between the upstream zone and the downstream zone and on which the wheels of the trays travel, and
on either side of the vertical midplane, an endless transmission belt where each transmission belt carries a plurality of counter-latches and has a lower length arranged so that the counter-latches carried by said lower length cooperate with the latches of the trays travelling on the lower transport line and an upper length arranged so that the counter-latches carried by said upper length cooperate with the latches of the trays travelling on the upper transport line, where each transmission belt is disposed to the outside with respect to the wheels, and
drive means arranged to drive each transmission belt,
where, at the downstream lift, each upper rail has a recess in which a gate is disposed arranged to open when a tray is transported from the lower rail above the upper rail and to close again when the wheels of said tray are above the upper rail and where, at the upstream lift, each lower rail has a recess in which a gate is disposed arranged to open when a tray is transported from an upper rail of the underlying pair, above the lower rail, and to close again when the wheels of said tray are above the lower rail.

Advantageously, in the vicinity of each gate, the rail concerned has a slot intended to allow passage of a latch of the tray when it is transported from an underlying rail onto said rail concerned.

Advantageously, each gate comprises at least one door, said at least one door being mounted hinged on the rail concerned between an open position in which said door is tilted to leave the recess clear and a closed position in which said door is closed to close the recess.

According to a particular embodiment, each gate comprises a single door mounted so as to be able to rotate on the rail concerned about a horizontal rotation axis parallel to the insertion direction.

According to a particular embodiment, each gate comprises a two doors each mounted so as to be able to rotate on the rail concerned about a horizontal rotation axis perpendicular to the insertion direction.

Advantageously, the or each door is forced towards its closed position by a draw spring installed between the or each door and the rail.

Advantageously, each lift comprises:
a chassis carrying at least one sub-tray intended to receive a tray,
a guidance system providing vertical guidance of the chassis,
a motor having a motor shaft able to rotate,
a main linkage having a first end mounted articulated on the chassis and a second end,
a first secondary linkage having a first end mounted articulated with the second end of the main linkage and a second end rigidly connected to the motor shaft.

Advantageously, each lift furthermore comprises a second secondary linkage symmetric with the first secondary linkage with respect to the main linkage and having first end mounted articulated with the second end of the main linkage and a second end mounted so as to be able to rotate about a rotation axis coaxial with the motor shaft.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 is a perspective view of a heat-treatment installation for food products according to the invention,

FIG. 2 is a perspective view of an enlargement of a downstream zone II of the installation in FIG. 1, FIG. 3 is a perspective view of an enlargement of an upstream zone III of the installation in FIG. 1,

FIG. 4 is an enlargement of a detail of the installation in FIG. 1,

FIG. 5 is an enlargement of a detail of the installation in FIG. 1,

FIG. 6 is a perspective view of a lift for the installation in FIG. 1,

FIG. 7 is a perspective view of the lift in FIG. 6,

FIG. 8 is a perspective view of the lift in FIG. 6,

FIG. 9 is an enlargement of a detail of the installation in FIG. 1,

FIG. 10 is a perspective view of a gate in the closed position,

FIG. 11 is a perspective view of the gate in FIG. 10 in the open position, and

FIG. 12 is a view similar to FIG. 9 for a variant embodiment.

### DETAILED DISCLOSURE OF EMBODIMENTS

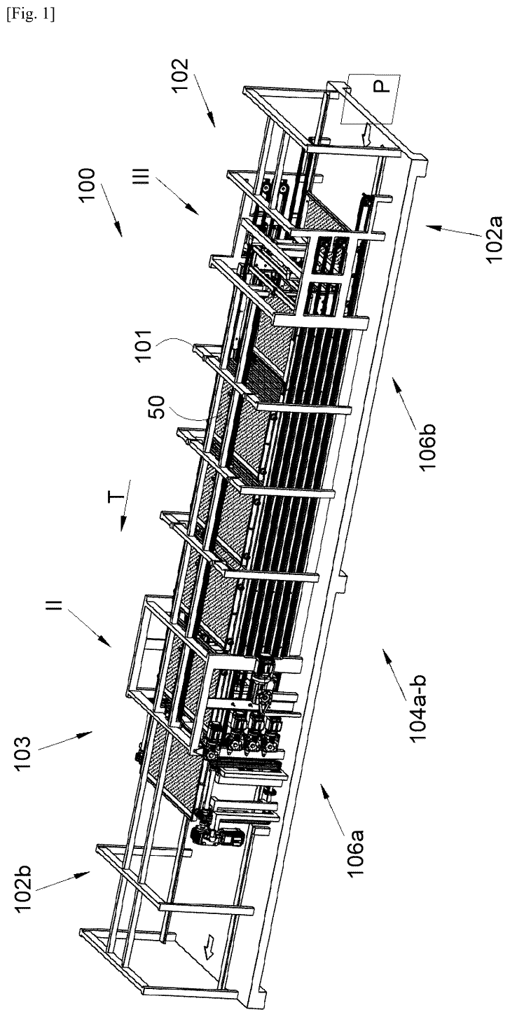

FIG. 1 shows a heat-treatment installation 100 making it possible for example to heat or cool food products that are disposed on trays 50 that pass through the heat-treatment installation 100, as explained below. The system for heating or cooling is not shown in order to simplify the Figs., but it may for example take the form of nozzles spraying heat or cold water onto the food products.

The heat-treatment installation 100 comprises a frame 102 that is secured to the floor and comprises here a plurality of arches 101 that are aligned one after the other parallel to a horizontal insertion direction T. The heat-treatment installation 100 extends between an inlet 102a by which the trays 50 arrive at the heat-treatment installation 100 and an outlet 102b by which the trays 50 leave the heat-treatment installation 100.

The insertion direction T is oriented from the inlet 102a to the outlet 102b and the heat-treatment installation 100 has a vertical midplane P parallel to the insertion direction T.

The heat-treatment installation 100 comprises a plurality of transport lines 104a-b extending parallel to the insertion direction T one above the other between an upstream zone III in the vicinity of the inlet 102a and a downstream zone II in the vicinity of the outlet 102b.

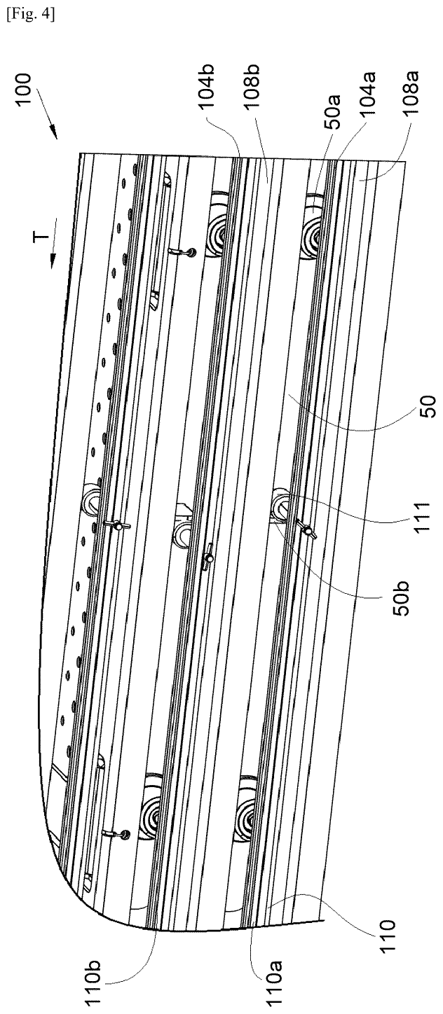

The heat-treatment installation 100 also comprises at least one tray 50 on which the food products are deposited and, as shown more clearly in FIG. 5, each tray 50 has, on either side of the vertical midplane P, two wheels 50a and a latch 50b. Here, the tray 50 has a bottom 51 perforated to allow, among other things, the passage of fluids.

In the downstream zone II, the heat-treatment installation 100 comprises a downstream lift 106a and, in the upstream zone III, the heat-treatment installation 100 comprises an upstream lift 106b, where each lift 106a-b lifts the tray 50 from a lower transport line 104a to an upper transport line 104b just above. Each lift 106a-b is secured to the frame 102.

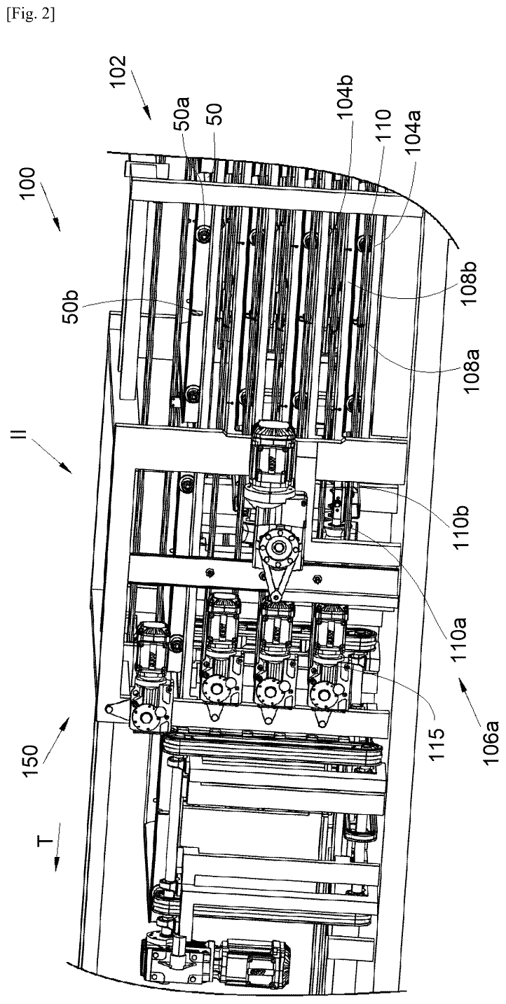

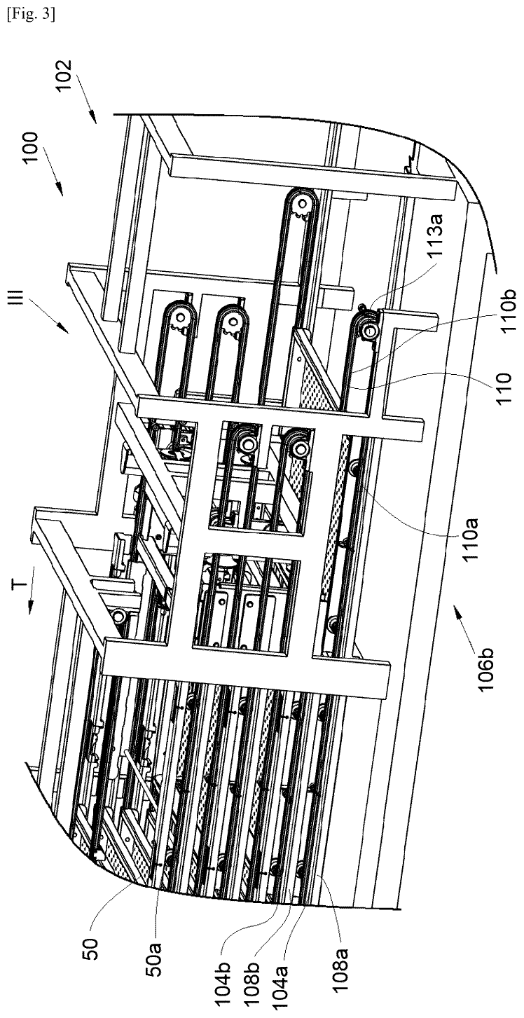

FIG. 2 shows the downstream zone II and FIG. 3 shows the upstream zone III. FIG. 4 shows two transport lines 104a-b.

For each pair consisting of a lower transport line 104a and an upper transport line 104b disposed above the lower transport line 104a, the heat-treatment installation 100 comprises, on either side of the vertical midplane P, a lower rail 108a corresponding to the lower transport line 104a and an upper rail 108b corresponding to the upper transport line 104b. The rails 108a-b are secured to the frame 102. The rails 108a-b extend parallel to the insertion direction T between the upstream zone III and the downstream zone II and are arranged so that the wheels 50a of the trays 50 travel thereon.

For each transport line 104a-b, there are thus two parallel rails 108a-b at the same height, and the trays 50 move along each transport line 104a-b.

In the same way, for each pair of transport lines 104a-b, the heat-treatment installation 100 comprises, on either side of the vertical plane P, an endless transmission belt 110 forming a loop. There are thus two transmission belts 110 for each pair of transport lines 104a-b.

Each transmission belt 110 has a lower length 110a arranged along the lower transport line 104a and an upper length 110b arranged along the upper transport line 104b. The lengths 110a-b are thus parallel to the insertion direction T. Each transmission belt 110 is here tensioned between two pulleys 113a (only one is visible in FIG. 3) mounted so as to be able to rotate on the frame 102 and is moved by suitable drive means 150, such as for example here a motor 115 carrying the second pulley for each transmission belt 110. It is also possible to provide for one and the same motor to drive a plurality of transmission belts 110 by means of return belts.

Each transmission belt 110 may be a notched belt or a chain, and each pulley is then a notched pulley.

There are thus two transmission belts 110 per pair of transport lines 104a-b, and a fault on a transmission belt 110 will require a simpler repair than in the case of the prior art, since the transmission belt 110 is shorter.

Each transmission belt 110 carries a plurality of counter-latches 111 that are oriented inwards.

The lower length 110a is arranged so that the counter-latches 111 that it carries cooperate with the latches 50b of the trays 50 travelling on the lower transport line 104a associated with the lower length 110a.

The upper length 110b is arranged so that the counter-latches 111 that it carries cooperate with the latches 50b of the trays 50 travelling on the upper transport line 104b associated with the upper length 110b.

Thus, when a counter-latch 111 moves with the transmission belt 110, it comes into contact with the latch 50b of a tray 50 and pushes it to make said tray 50 travel. Naturally, the counter-latches 111 are disposed so that a counter-latch 111 pushes on each latch 50b of a tray 50 to provide an identical thrust on each side of the tray 50.

Each transmission belt 110 is disposed to the outside with respect to the wheels 50a of the trays 50 so that the tray 50 is thus entirely between the transmission belts 110 and so that its vertical movement by the lifts 106a-b is not interfered with by an interaction between the wheels 50a and the transmission belts 110. There is thus a part of each rail 108a-b that is located to the inside with respect to the transmission belts 110.

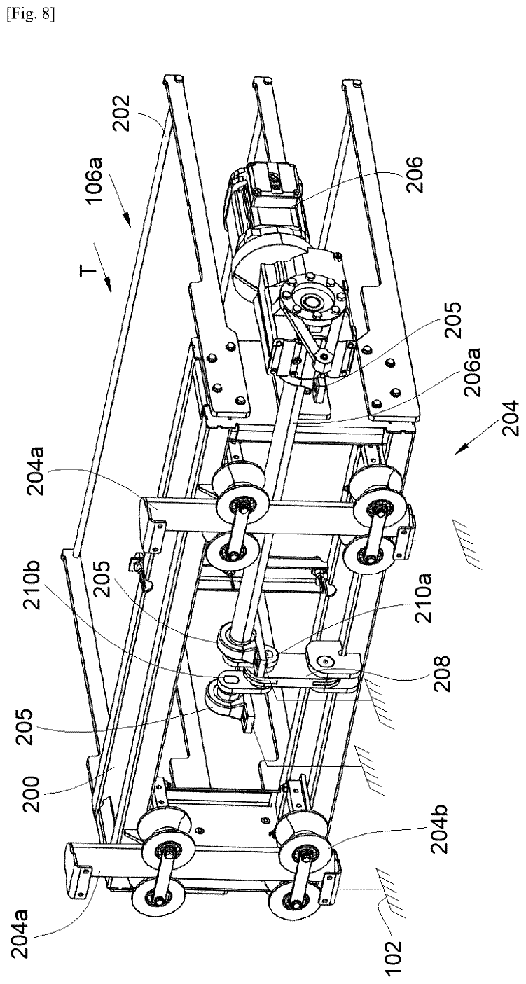

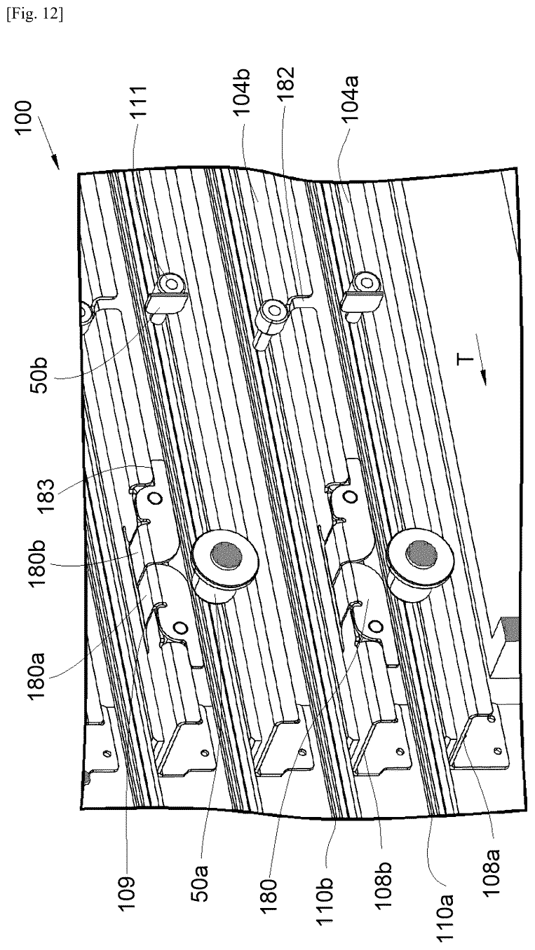

FIGS. 9 to 11 show a first embodiment of the invention and FIG. 12 shows a variant embodiment.

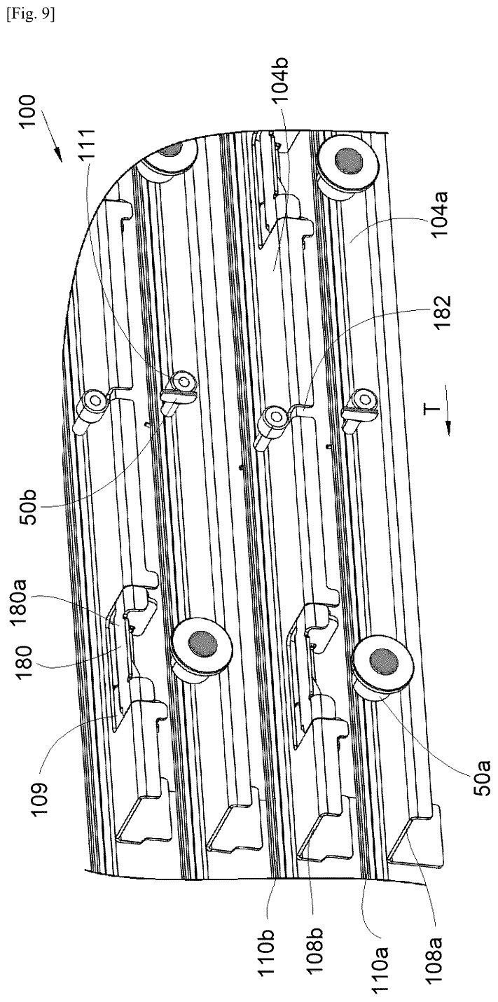

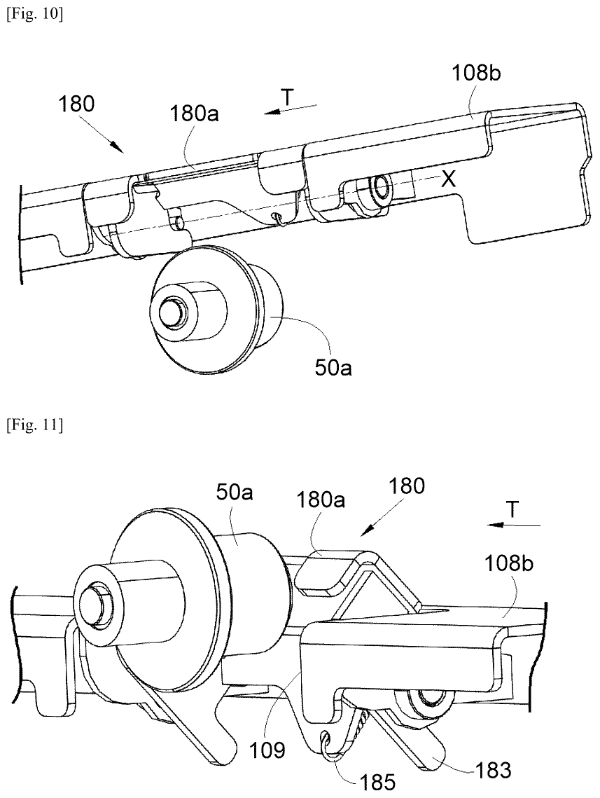

Thus, at the downstream lift 106a, each upper rail 108b has a recess 109 in which a gate 180 is disposed, arranged to open when a tray 50 is transported from the lower rail 108a above the upper rail 108b and to close again when the wheels 50a of said tray 50 are above the upper rail 108b. Thus there is one recess 109 per wheel 50a, i.e. two on each side. When the tray 50 is on the lower rail 108a (FIG. 10), the gate 180 is in the closed position and, when the tray 50 is moved upwards (FIG. 11), each wheel 50a comes into abutment against the gate 180 and lifts it in order to place it in the open position and, when the wheel 50a has passed above the gate 180, the latter closes again by gravity to extend the upper rail 108b and to close off the recess 109. The tray 50 can then be placed again on the upper rails 108b.

In the same manner but with a shift upwards, at the upstream lift 106b, each lower rail 108a has a recess 109 in which a gate 180 is disposed, arranged to open when a tray 50 is transported from an upper rail 108b of the underlying pair, above the lower rail 108a, and to close again when the wheels 50a of said tray 50 are above the lower rail 108a. The lower rail 108a of the lowest pair of transport lines 104a-b does not have a gate since the trays 50 arrive via the inlet 102a rather than underneath.

Each recess 109 is located to the inside with respect to the transmission belts 110.

The operation of the heat-treatment installation 100 is then as follows for a tray 50, knowing that the trays 50 move one after the other. A loaded tray 50 arrives by the inlet 102a, where it is taken up, passing under the upstream lift 106b following the lower rails 108a of the lowest pairs. Once it arrives at the downstream lift 106a, the tray 50 is lifted so as to come onto the upper rails 108b of the same pair, and the tray 50 is moved towards the upstream lift 106b. Once it arrives at the upstream lift 106b, the tray 50 is lifted so as to come onto the lower rails 108a of the pair above, and the tray 50 is moved towards the downstream lift 106a. The zigzag movement continues until the last stage is reached, which comprises solely lower rails 108a that guide the tray 50 towards the outlet 102b, passing above the downstream lift 106a, and the tray 50 then leaves the heat-treatment installation 100. Each lift 106a-b redescends after each rise in order to return to its low position and to await the next tray 50.

In the embodiment of the invention presented in FIG. 1, the heat-treatment installation 100 comprises a handling system 103 that moves the tray 50 downwards and can take any form known to a person skilled in the art.

Thus, each tray 50 passes over each transport line 104a-b between the lifts 106a-b.

Furthermore, the trays 50 are therefore not rigidly connected to the transmission belts 110 and can easily be removed from the heat-treatment installation 100 in order to be washed, replaced, etc.

The counter-latches 111 are arranged so that, when the tray 50 rises, the counter-latch 111 of the departure transport line 104a-b is on the other side of the latch 50b with respect to the counter-latch 111 of the incoming transport line 104b-a since the direction of movement of the tray 50 changes direction between the two transport lines 104a-b.

In the vicinity of each gate 180, the rail 108a-b to which said gate 180 relates has a slot 182 that is arranged to allow passage of a latch 50b of the tray 50 when it is transported from an underlying rail onto said rail 108a-b concerned, and thus the latch 50b passes through the slot 182. The width of the slot 182 parallel to the insertion direction T is less than the diameter of the wheels 50a to prevent the latter passing through the slots when they travel over them.

To avoid producing slots 182, it is possible to mount the latches 50b on pivot connections about axes parallel to the insertion direction T where the pivot connection comprises a return element, such as a spring, which returns the latch 50b to its position of cooperation with the counter-latches 111.

In the embodiment of the invention presented in FIGS. 9 to 11, each gate 180 comprises a single door 180a.

The door 180a is mounted hinged on the rail 108a-b concerned between an open position (FIG. 11) in which the door 180a is tilted, here upwards, to leave clear the recess 109 and to allow passage of the wheel 50a, and a closed position (FIG. 10) in which the door 180a is tilted, here downwards, to close off the recess 109.

The door 180a is able to rotate about a horizontal rotation axis X parallel to the insertion direction T. Thus, when the wheel 50a is under the door 180a and the tray 50 is raised, the wheel 50a comes into contact with the door 180a and tilts it upwards in order to leave clear the recess 109 and to allow passage of the wheel 50a. When the wheel 50a has passed, the door 180ab closes again under the action of gravity as far as the starting position. The tray 50 can then be lowered again to place the wheels on the door 180a, which extends the rail 108a-b and closes the recess 109.

The departure position is implemented by a stop system 183 between the door 180a and the rail 108a-b.

To assist in returning the door 180a to the closed position, a draw spring 185 can be installed between the door 180a and the rail 108a-b.

In the embodiment of the invention presented in FIG. 12, each gate 180 comprises two doors 180a-b.

Each door 180a-b is mounted hinged on the rail 108a-b concerned between an open position in which the door 180a-b is tilted, here upwards, to leave clear the recess 109 and to allow passage of the rail 50a, and a closed position in which the door 180a-b is tilted, here downwards, to close the recess 109.

Each door 180a-b is able to rotate about a horizontal rotation axis perpendicular to the insertion direction T. Thus, when the wheel 50a is under the doors 180a-b and the tray 50 is raised, the wheel 50a comes into contact with the doors 180a-b and tilts them upwards in order to leave clear the recess 109 and to allow passage of the wheel 50a. When the wheel 50a has passed, the door 180a-b closes again under the action of gravity as far as the starting position. The tray 50 can then be lowered again to place the wheels on the doors 180a-b, which extend the rail 108a-b and close the recess 109.

The departure position is implemented by a stop system 183 between each door 180a-b and the rail 108a-b.

As before, to assist in returning each door 180a-b to the closed position, a draw spring can be installed between each door 180a-b and the associated rail 108a-b.

Thus, in general terms, each gate 180 comprises at least one door 180a-b, said at least one door 180a-b being mounted hinged on the rail 108a-b concerned between the open position in which said door 180a-b is tilted to leave the recess 109 clear and a closed position in which said door 180a-b is tilted to close the recess 109.

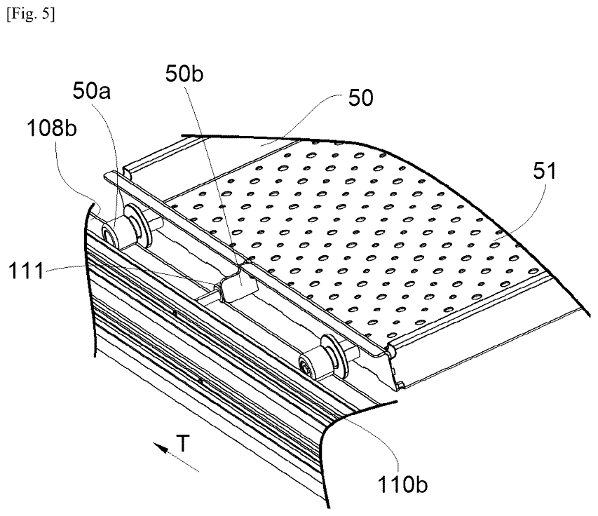

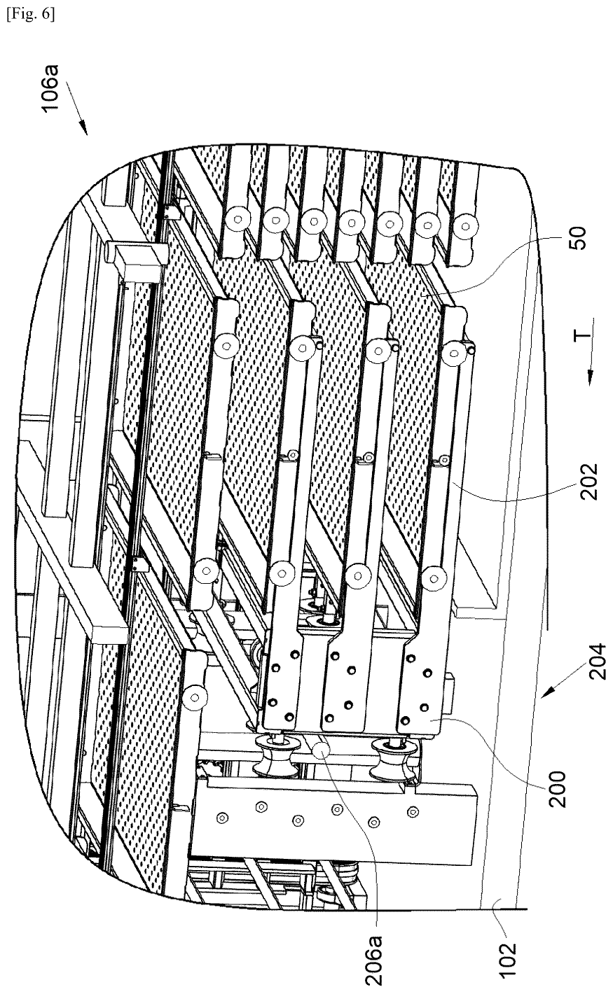

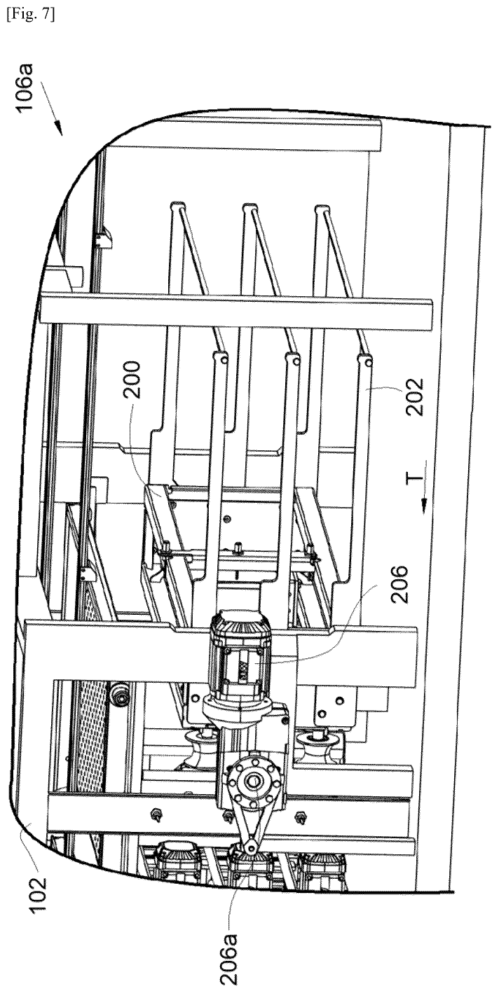

FIGS. 6 to 8 show various views of the downstream lift 106a, but the structure of the upstream lift 106b is similar and the following description is therefore valid for both. The downstream lift 106a is mounted so as to be able to move vertically with respect to the frame 102.

The downstream lift 106a comprises a chassis 200 carrying at least one sub-tray 202 that is intended to receive a tray 50. Here there are three sub-trays 202 since there are three pairs of transport lines 104a-b. Each sub-tray 202 thus receives a tray 50 and, when the downstream lift 106a is raised, the trays 50 are unloaded.

The downstream lift 106a also comprises a guidance system 204 that provides vertical guidance of the chassis 200 upwards and downwards.

In the embodiment of the invention presented here, the guidance system 204 comprises two runners 204a that are secured vertically to the frame 102 and, for each runner 204a, four rollers 204b secured in pairs on either side of the runner 204a to grip it, and each roller 204b is mounted on the chassis 200 so as to be able to rotate about a horizontal axis. Thus, when the chassis 200 rises or falls along the runners 204a, the rollers 204b roll along the associated runner 204a.

The downstream lift 106a is driven by a motor 206 secured to the frame 102 and having a motor shaft 206a that is therefore able to rotate about a horizontal axis. Here, the motor shaft 206a has an angle of 90° with respect to the axis of the motor 206 through the installation of a direction-change system.

The rotational guidance of the motor shaft 206a is provided here by two bearings 205 secured to the frame 102.

The downstream lift 106a also has a main linkage 208 having a first end mounted articulated on the chassis 200 and a second end. The articulation of the first end of the main linkage 208 is a rotation with its axis parallel to the motor shaft 206a.

The downstream lift 106a also has a first secondary linkage 210a having a first end mounted articulated with the second end of the main linkage 208, also a rotation about an axis parallel to the motor shaft 206a, and a second end rigidly connected to the motor shaft 206a, here through one of the bearings 205.

Thus, when the motor shaft 206a rotates, it rotates the first secondary linkage 210a, the first end of which is shifted, driving the second end of the main linkage 208 and, when the secondary linkage 210a makes a complete turn, the main linkage 208 rises and then falls, driving the chassis 200 in the same direction.

The downstream lift 106a is thus relatively simple to implement using a system of linkages.

For reasons of balancing of forces, the downstream lift 106a furthermore comprises a second secondary linkage 210b that is symmetric with the first secondary linkage 210a with respect to the main linkage 208 and which has a first end mounted articulated with the second end of the main linkage 208 and a second end mounted so as to be able to rotate about a rotation axis coaxial with the motor shaft 206a.

The second end of the secondary linkage 210b is mounted articulated on the frame 102 by means of a bearing 205 secured to the frame 102.

1. A heat-treatment installation having a vertical midplane parallel to an insertion direction and comprising:
a plurality of transport lines extending parallel to the insertion direction one above the other between an upstream zone and a downstream zone,
at least one tray having, on either side of the vertical midplane, two wheels and a latch.
a downstream lift in the downstream zone and an upstream lift in the upstream zone wherein each lift is arranged to move at least one tray from a lower transport line to another upper transport line,
for each pair of a lower transport line and an upper transport line:
on either side of the vertical midplane, a lower rail (108a) and an upper rail extending parallel to the insertion direction between the upstream zone and the downstream zone and on which the wheels of the trays travel, and
on either side of the vertical midplane, an endless transmission belt (110) where each transmission belt carries a plurality of counter-latches and has a lower length arranged so that the counter-latches carried by said lower length cooperate with the latches of the trays travelling on the lower transport line and an upper length arranged so that the counter-latches carried by said upper length cooperate with the latches of the trays travelling on the upper transport line, where each transmission belt is disposed to the outside with respect to the wheels, and
drive means arranged to drive each transmission belt,
where, at the downstream lift, each upper rail has a recess in which a gate is disposed arranged to open when a tray is transported from the lower rail above the upper rail and to close again when the wheels of said tray are above the upper rail and where, at the upstream lift (106b), each lower rail has a recess in which a gate is disposed arranged to open when a tray is transported from an upper rail of the underlying pair, above the lower rail, and to close again when the wheels of said tray are above the lower rail.

2. The heat-treatment installation according to claim 1, wherein in the vicinity of each gate, the rail concerned has a slot that is arranged to allow passage of a latch of the tray when it is transported from an underlying rail onto said rail concerned.

3. The heat-treatment installation according to claim 1, wherein each gate comprises at least one door, said at least one door being mounted hinged on the rail concerned between an open position in which said door is tilted to leave the recess clear and a closed position in which said door is tilted to close the recess.

4. The heat-treatment installation according to claim 3, wherein each gate comprises a single door mounted so as to be able to rotate on the rail concerned about a horizontal rotation axis parallel to the insertion direction.

5. The heat-treatment installation according to claim 3, wherein each gate comprises two doors each mounted so as to be able to rotate on the rail concerned about a horizontal rotation axis perpendicular to the insertion direction.

6. The heat-treatment installation according to claim 3, wherein the or each door is forced towards its closed position by a draw spring installed between the or each door and the rail.

7. The heat-treatment installation according to claim 1, wherein each lift comprises:
a chassis carrying at least one sub-tray that is intended to receive a tray,
a guidance system providing vertical guidance of the chassis,
a motor having a motor shaft able to rotate,
a main linkage having a first end mounted articulated on the chassis and a second end,
a first secondary linkage having a first end mounted articulated with the second end of the main linkage and a second end rigidly connected to the motor shaft.

8. The heat-treatment installation according to claim 7, wherein each lift furthermore comprises a second secondary linkage that is symmetric with the first secondary linkage with respect to the main linkage and having a first end mounted articulated with the second end of the main linkage and a second end mounted so as to be able to rotate about a rotation axis coaxial with the motor shaft.
